(19) United States
(12) Patent Application Publication
(10) Pub. No.: US 2023/0152446 A1
(43) Pub. Date: May 18, 2023

(54) DEFORMABLE RADAR POLYGON SYSTEMS AND METHODS FOR A VIRTUAL BUMPER

(71) Applicant: Volvo Car Corporation, Goteborg (SE)

(72) Inventors: Sihao Ding, Sunnyvale, CA (US); Xiangyu Gao, Seattle, WA (US); Harshavardhan Reddy Dasari, Santa Clara, CA (US)

(21) Appl. No.: 17/980,618

(22) Filed: Nov. 4, 2022

Related U.S. Application Data
(60) Provisional application No. 63/280,168, filed on Nov. 17, 2021.

(51) Int. Cl. G01S 13/931; G01S 13/89

(52) U.S. Cl. CPC G01S 13/931; G01S 13/89

(57) ABSTRACT

The present disclosure adds automotive millimeter-wave (mmWave) radars to the current perception system and makes them an effective augmentation for ultrasonic sensors (USSs). Relying on the superior range and Doppler resolution, mmWave radars generate denser point clouds than the intersection detections of USSs, making it possible to form a more robust and accurate radar occupancy grid. The radar occupancy grid can be formulated as a polygon with multiple nodes. Thus,, the memory-consuming occupancy grid is simplified as a polygon that consists of a bunch of points, which can be used in the downstream application for relieving computational burden. Radars measure and estimate the Doppler velocity of detected targets such that one can assign a moving velocity to each node of the radar polygon. This makes it possible to predict the shape of a future radar polygon and feed the predicted radar polygon to downstream applications.

### CROSS-REFERENCE TO RELATED APPLICATION

The present disclosure claims the benefit of priority of co-pending U.S. Provisional Pat. Application No. 63/280,168, filed on Nov. 17, 2021, and entitled “DEFORMABLE RADAR POLYGON SYSTEMS AND METHODS FOR A VIRTUAL BUMPER,” the contents of which are incorporated in full by reference herein.

### TECHNICAL FIELD

The present disclosure relates generally to the automotive field. More particularly, the present disclosure relates to deformable radar polygon systems and methods for a virtual bumper.

### BACKGROUND

Vehicles have been equipped with ultrasonic sensors (USSs) for years as part of their Advanced Driver Assistance Systems (ADASs). These sensors have been primarily used for parking guidance and blind spot detection. Parking applications rely upon USS data to detect open parking spots, and autonomous vehicles use USS data to detect conditions around the vehicle. The detection results of USSs are presented as an occupancy grid, where the pixel value of a covered region is 1, and otherwise 0. One big concern for a USS-based occupancy grid is the relatively short detection range and high false alarm rate because of air changes (temperature, wind, etc.), which makes the occupancy grid non-coherent across time and worsens the performance of a route planning algorithm used in an automatic parking application. Further, a conventional USS-based occupancy grid requires significant memory consumption.

### SUMMARY

To solve this problem, the present disclosure adds automotive millimeter-wave (mmWave) radars to the current perception system and makes them an effective augmentation for USSs. There are several reasons for using such radar sensors, including good penetration ability and robustness to environmental changes. First, relying on the superior range and Doppler resolution, mmWave radars generate denser point clouds than the intersection detections of USSs, making it possible to form a more robust and accurate radar occupancy grid. Second, the radar occupancy grid can be formulated as a polygon with multiple nodes. The region within the polygon is assumed as the safety region (i.e., equivariant to have pixel value 0), and the region outside of the polygon is assumed as the covered/dangerous region. In this way, the memory-consuming occupancy grid is simplified as a polygon that consists of a bunch of points, which can be used in the downstream application for relieving computational burden. e.g., route planning, collision avoidance, etc. Third, mmWave radars measure and estimate the Doppler velocity of detected targets such that one can assign a moving velocity to each node of the radar polygon. This makes it possible to predict the shape of a future radar polygon and feed the predicted radar polygon to downstream applications. A polygon with predictable shape change is referred to herein as a “deformable polygon.” If a real vehicle bumper absorbs impact upon a collision, the virtual vehicle bumper of the present disclosure provides a protection area provided by the vehicle perception system using radar sensors that complement the USS occupancy grid.

The present disclosure develops and utilizes a radar polygon formation algorithm using point cloud input, compares the performance of the radar polygon and USS occupancy qualitatively and quantitatively, and verifies the deformable polygon idea in real applications with collected data.

In one illustrative embodiment, the present disclosure provides a system, including: memory storing instructions executed by a processor to project a 3D x-y-z point cloud into a 2D plane by selecting all points with a predetermined height and projecting the points to a 2D x-y plane by compressing the heights, sampling each azimuth direction with a fixed angle Δθ, for each sampling sector, selecting a closest point, if it exists, and locating a virtual point at a boundary otherwise, and connecting all selected points in sequence to form a deformable radar polygon.

In another illustrative embodiment, the present disclosure provides a method, including: projecting a 3D x-y-z point cloud into a 2D plane by selecting all points with a predetermined height and projecting the points to a 2D x-y plane by compressing the heights, sampling each azimuth direction with a fixed angle Δθ, for each sampling sector, selecting a closest point, if it exists, and locating a virtual point at a boundary otherwise, and connecting all selected points in sequence to form a deformable radar polygon.

In a further illustrative embodiment, the present disclosure provides a non-transitory computer-readable medium comprising instructions stored in a memory and executed by a processor to carry out the steps, comprising: projecting a 3D x-y-z point cloud into a 2D plane by selecting all points with a predetermined height and projecting the points to a 2D x-y plane by compressing the heights, sampling each azimuth direction with a fixed angle Δθ, for each sampling sector, selecting a closest point, if it exists, and locating a virtual point at a boundary otherwise, and connecting all selected points in sequence to form a deformable radar polygon.

### BRIEF DESCRIPTION OF THE DRAWINGS

The present disclosure is illustrated and described herein with reference to the various drawings, in which:

FIG. 1 is a schematic diagram illustrating one illustrative embodiment of the formation of a deformable radar polygon in accordance with the systems and methods of the present disclosure;

FIG. 2 is a schematic diagram illustrating one illustrative embodiment of the radar polygon smoothing scheme in accordance with the systems and methods of the present disclosure;

FIG. 3 is a schematic diagram illustrating one illustrative embodiment of the use of a deformable radar polygon in accordance with the systems and methods of the present disclosure;

FIG. 4 shows an illustrative radar sensor and the placement of four such radar sensors, the illustrated arced regions representing the radar field of view (FoV) and the illustrated circles representing the USSs;

FIG. 5 is a series of images showing (left) the USS occupancy grid, (middle) radar polygon in accordance with the systems and methods of the present disclosure, and (right) the shrunken radar polygon;

FIG. 6 is a series of radar polygon results (eight frames) for a moving pedestrian, with the radar polygon filled with a light color and the Doppler velocity of each vertex represented as an arrow with scaling;

FIG. 7 is a table illustrating the effects of sampling angle on radar polygon results;

FIG. 8 is a network diagram of a cloud-based system for implementing the various systems and methods of the present disclosure;

FIG. 9 is a block diagram of a server/processing system that may be used in the cloud-based system of FIG. 8 or stand-alone; and

FIG. 10 is a block diagram of a remote device that may be used in the cloud-based system of FIG. 8 or stand-alone.

### DETAILED DESCRIPTION

In general, radar is preferable to USSs for the following reasons:
Automotive mmWave radar is good replacement for USSs because it sends an electromagnetic wave with exceedingly small wavelength (i.e., a few millimeters), which provides good penetration ability and is robust to environment changes, such as temperature, wind, rain, snow, etc.
Automotive mmWave radar can provide up to 4D point clouds with position estimation in x, y, z directions and Doppler velocity estimation for each point. The Doppler velocity measures the radial movement component of a moving target/obj ect.
Automotive mmWave radar has impressive range resolution (e.g., that can achieve 4 cm) due to the large available 4 GHz bandwidth at a 77 GHz frequency band, and has superior Doppler velocity resolution (e.g., that can discriminate two targets with less than 0.1 m/s Doppler difference).
For automotive mmWave radar, the multi-path propagation of electromagnetic waves makes it possible to see the non-line-of-sight (i.e., covered) objects in front of the radar.

To generate a deformable radar polygon, the following steps are provided: (1) initial formation via sampling, (2) predictable polygon change according to Doppler velocity, and (3) smoothing using history memory.

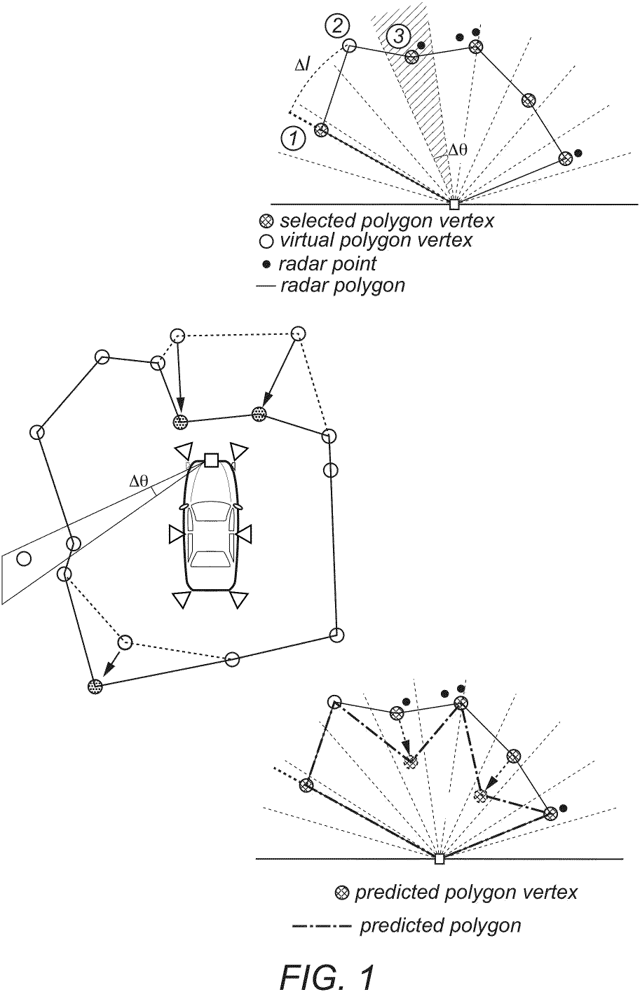

Since the present disclosure is interested in the occupancy grid in the 2D bird’s-eye-view (BEV), the first step is to project a 3D x-y-z point cloud into the 2D plane. That is, one selects all points with reasonable height (e.g., greater than -1.5 m and less than 3 m) and projects them to the 2D x-y plane by compressing the height. Then, each azimuth direction is sampled with fixed angle Δθ, as illustrated in FIG. 1. For each sampling sector, the closest point is selected, if it exists, and a virtual point located at the boundary is made otherwise. Selected points include 1 and 3 in FIG. 1, and virtual points include 2. The checking process is done by measuring the arc length Δl between the virtual vertex and the last selected vertex. The virtual vertex is added only if it is longer than a predefined threshold lₜₕᵣ. All vertices plus the origin point are connected in sequence to form the radar polygon. To smooth the sampling results, one can make every two consecutive samplings share an overlapping region. All selected points are then connected in sequence to form the radar polygon.

Related to the deformable polygon and polygon prediction, the nodes that constitute the radar polygon have Doppler velocity, which can describe their instant movement along the radial direction (i.e., the direction from node to radar). By assuming that the moving velocity of a node/point is constant within a short period of time, one can estimate the future location of a node by calculating and adding its radial movement using current Doppler velocity. That is, for a node point with location (x, y) and Doppler velocity v detected by radar sensor (xₛ, yₛ), its radial movement (Δx, Δy) within duration Δt is given by:

$$\left(Δ x , Δ y\right) = A ⋅ \left(x - {x}_{s} , y - {y}_{s}\right)$$

$$A = v ⋅ Δ t / \sqrt{{\left(x - {x}_{s}\right)}^{2} + {\left(y - {y}_{s}\right)}^{2}}$$

Therefore, by adding the estimated radial movement to the node point, one can predict its new location (x′,y′) = (x, y) + (Δx,Δy). It is worth noting that one can predict the future-frame radar polygon based on the current polygon and the radar polygon is “deformable” as the predictable shape changes. That is, one can predict the new location of each point of current polygon as above (ignoring the movement of the virtual points) and connect all predicted nodes to form the new polygon.

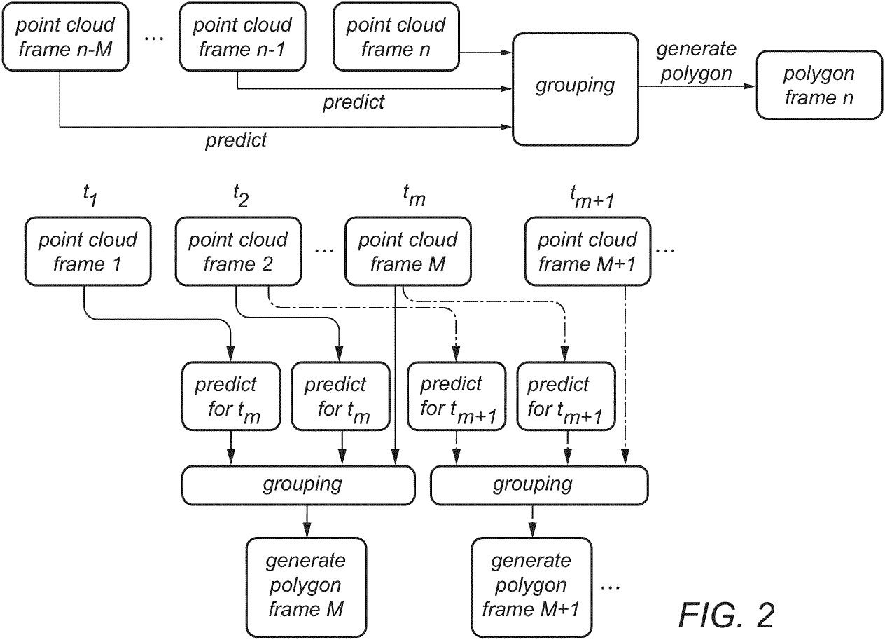

The above provides how to generate the radar polygon using the point cloud of one frame and how to predict the polygon for future frames. Due to noise and multi-path issues, there always exist false alarms and missing detections in radar point clouds, which can make radar polygons incoherent across frames/time. To smooth the generated polygons across time, FIG. 2 provides a scheme that utilizes the history information (i.e., memory) to help improve polygon results, compensating for false alarms and missing detections. Specifically, when generating the polygon for frame n, one not only uses the point cloud of frame n, but also utilizes the stored last M-frame point cloud data. The stored data for history frames needs to be updated to match the current timestamp before grouping them with current-frame data. The update procedure is to predict the new location of point clouds at current frame/timestamp using the method provided above. Finally, the grouped point cloud is treated as the new input to form the polygon for frame n. A restriction is added to the first policy of polygon formation, that is, the closest point is selected that has at least k points within a dₜₕᵣ region as a vertex. By applying this restriction, false alarms are eliminated that appear once in a few frames among all M.

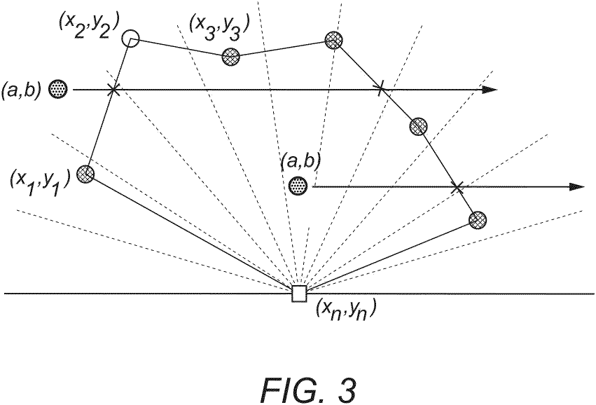

Now, as illustrated in FIG. 3, the present disclosure provides how to detect if a point (for example, a point of a vehicle body) is within the polygon to avoid a potential collision. There is a point (a, b) that needs to be checked if it has any collision to the region outside of the polygon. This problem is equivalent to ask whether point (a, b) in the plane lies inside, outside, or on the boundary of the polygon, using an even-odd rule algorithm. Mathematically, the horizontal line starting from point (a, b) (to its right) intersects edge (x1,y1)→(x2,y2) can be expressed as:

$$i f \frac{\left(b - {y}_{1}\right) \left({x}_{2} - {x}_{1}\right)}{{y}_{2} - {y}_{1}} + {x}_{1} - a > 0 a n d$$

$$m i n \left({y}_{1} , {y}_{2}\right) < b < m a x \left({y}_{1} , {y}_{2}\right)$$

Thus, assuming the polygon is sorted (in azimuth angle) with vertices (x1, y1), (x2, y2), ... (xn, yn), and the point that needs to be checked is (a, b), then a detection function F is defined as Equation (1).

$$\text{F} \left({a}_{1} b\right) = \left[\begin{matrix}{y}_{1} ⋯ {y}_{2} & {x}_{2} - {x}_{1} \\ {y}_{2} ⋯ {y}_{3} & {x}_{3} - {x}_{2} \\ ⋮ & ⋮ \\ {y}_{n - 1} - {y}_{n} & {x}_{n} - {x}_{n - 1} \\ {y}_{n} - {y}_{1} & {x}_{1} - {x}_{n}\end{matrix}\right] \left[\begin{matrix}a \\ b\end{matrix}\right] + \left[\begin{matrix}{x}_{1} \left({y}_{2} - {y}_{1}\right) - {y}_{1} \left({x}_{2} - {x}_{1}\right) \\ {x}_{2} \left({y}_{3} - {y}_{2}\right) - {y}_{2} \left({x}_{3} - {x}_{2}\right) \\ ⋮ \\ {x}_{n - 1} \left({y}_{n} - {y}_{n - 1}\right) - {y}_{n - 1} \left({x}_{n} - {x}_{n - 1}\right) \\ {x}_{n} \left({y}_{1} - {y}_{n}\right) - {y}_{n} \left({x}_{1} - {x}_{n}\right)\end{matrix}\right]$$

$$\text{F} \left(a , b\right) = \text{P} \left[{\text{Y}}_{\text{n}} - {\text{X}}_{\text{n}}\right] \left[\begin{matrix}a \\ b\end{matrix}\right] - \left({\text{PY}}_{\text{n}}\right) ⊙ {\text{X}}_{\text{n}} + \left({\text{PX}}_{\text{n}}\right) ⊙ {\text{Y}}_{\text{n}}$$

where

$${\text{P}}_{\text{n} \times \text{n}} = \left[\begin{matrix}1 & - 1 & 0 & … & 0 & 0 \\ 0 & 1 & - 1 & … & 0 & 0 \\ ⋮ & ⋮ & ⋮ & ⋱ & ⋮ & ⋮ \\ 0 & 0 & 0 & … & 1 & - 1 \\ - 1 & 0 & 0 & … & 0 & 1\end{matrix}\right]$$

and

$$⊙$$

is the Hadamard product (element-wise multiplication). The output of F is a column vector, and one needs to check the sign of each vector element to make a decision. That is, one finds a point (a0, b0) that needs be located within the polygon and checks if the vector F(a, b) has the same sign as F(a0, b0). If yes, then the point (a, b) is located within the polygon as well. If no, then (a, b) is outside of or on the polygon.

Equation (1) can be simplified to matrix-represented Equation (2) using matrix P, vector Xn = [x1, x2, ... xn]^{T} and Yn = [y1, y2, ... yn]^{T}.

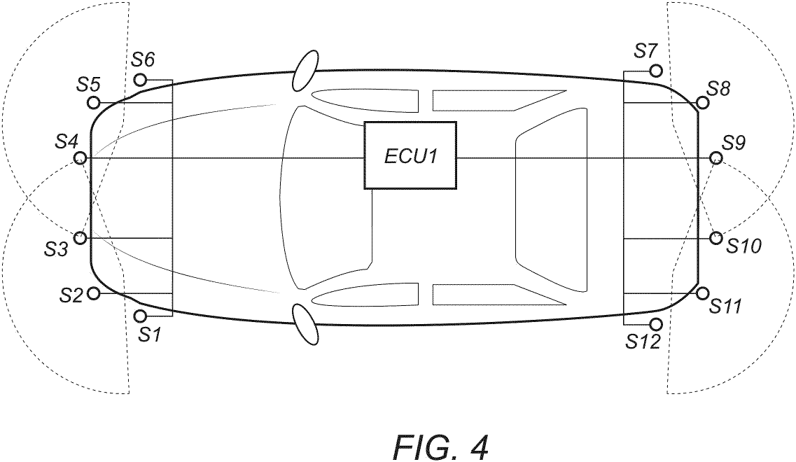

In terms of the evaluation testbed, FIG. 4 shows an illustrative radar sensor and the placement of four such radar sensors, the illustrated arced regions representing the radar FoV and the illustrated circles representing the USSs. Two radar sensors are placed in the front of test vehicle and two radar sensors are placed in the rear of the test vehicle with certain orientation (as shown in FIG. 4). For each radar, the maximum detectable range is 25 meters, and the FoV is 120 degrees. The radars are synchronized to the existing USSs and camera system using a timestamp. The current test vehicle was also equipped with twelve USSs for short range applications. The evaluation testbed may represent an operational configuration as well.

Experiments were performed at a parking lot and indoor garage with a classic car backing off scenario. After implementing the proposed algorithm on a collected radar point cloud, the radar polygon results were obtained with comparison to USS occupancy grids, with qualitative and quantitative evaluations provided as below.

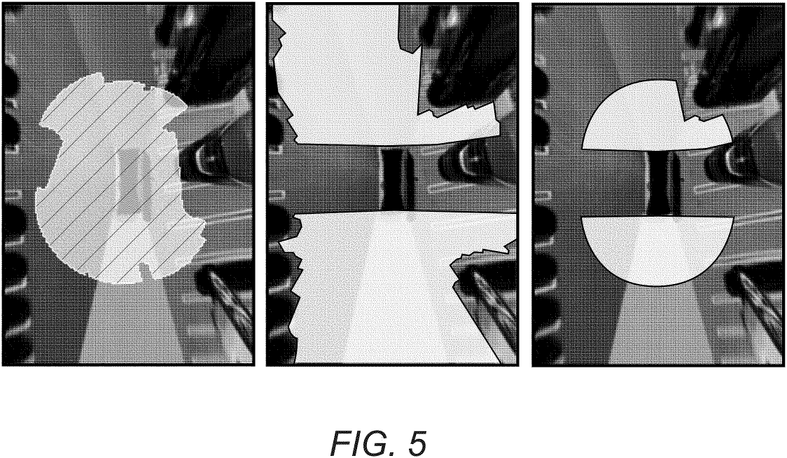

Comparing radar and USS in the parking scenario, one shot from the resulting radar polygon video is shown in the middle of FIG. 5. The radar polygon is filled with a light color and is plotted on the top of the BEV figure. This shows that radar polygon describes a more accurate and complete occupancy region than that of the USS (left image of FIG. 5), with the clear contour detection of surrounding vehicles. There are some mismatches between the radar polygon and the BEV image, which is highly likely caused by the system synchronization and projection errors.

As compared to the USS, the radar polygon covers larger field of view within the BEV image since the detectable range of radar is almost 5 times larger than that of a USS. When one shrinks the radar detectable range to 5 m (the same as a USS), the corresponding radar polygon is presented in the right of FIG. 5. From this comparison, the shrunken radar polygon is more robust and has fewer false alarms by showing shows less notches in the occupied region.

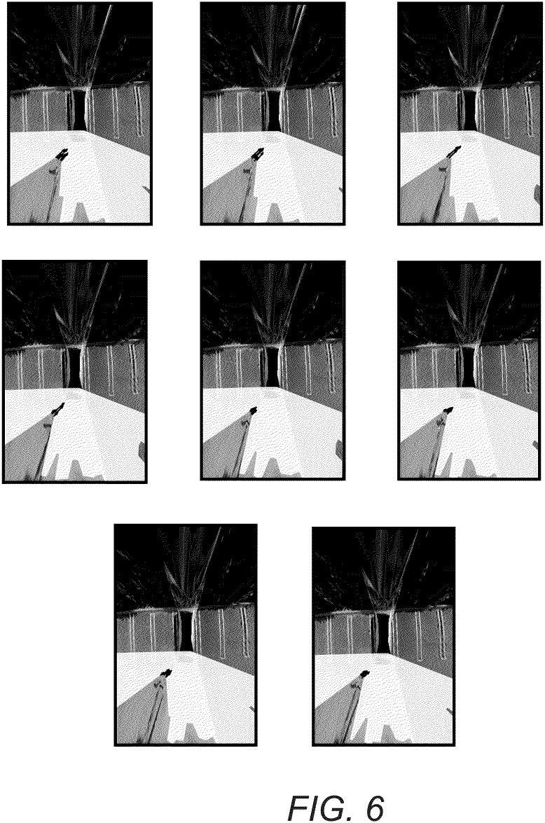

The radar detection capability was verified for pedestrians around the parked vehicle by showing the sequence of radar polygon results in FIG. 6. The polygons clearly avoid the region occupied by the pedestrian and show the Doppler velocity of the pedestrian at the vertices using arrows. The direction of each arrow guides the moving direction of the vertex and the length of it represents the estimated moving distance.

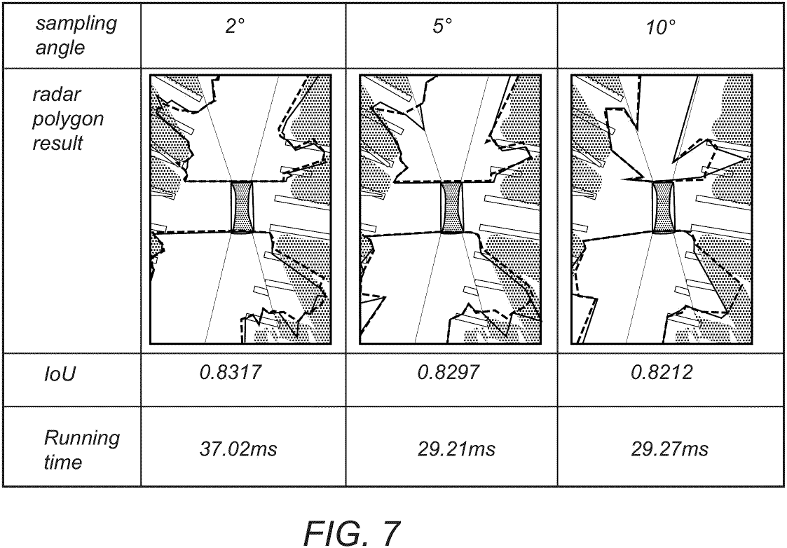

The deformable radar polygon concept was verified by one-to-one comparing the ground truth radar polygon and the predicted polygon from the last frame. One example is illustrated in the first column of the table of FIG. 7, where the ground truth radar polygon is filled with a light color and the predicted polygon is plotted with a dotted line. It is clear that the predicted polygon is mostly overlapped with the ground truth, which primitively verifies the correctness of the deformable radar polygon. The intersection of union (IoU) was calculated between two polygons and provided 0.9143 for the example frame, and 0.8317 for all averaged frames, which quantitively shows a good prediction performance. The running time of the proposed algorithm is about 37.02 ms with parameter M=4, which is sufficient for real-time on-board processing and 10 FPS radar scanning frequency.

In the table of FIG. 7, the polygon results and corresponding IoU and running tine are also shown for the proposed algorithm with other sampling angle configurations (5°, 10°). From comparison, the 2° sampling angle provided better polygon results and IoU evaluation with the price of increased running time.

Thus, the present disclosure details the proposed radar polygon formation algorithm using point cloud input, compares the performance of radar polygon and USS occupancy qualitatively and quantitatively. The results show that the radar polygon generated by four radars is more robust and accurate than the USS occupancy grid generated by twelve USSs. The deformable polygon idea is verified by showing high IoU correlation between the predicted radar polygon and ground truth using real collected data.

It is to be recognized that, depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially. It should be noted that the algorithms of the present disclosure may be implemented on an embedded processing system running a real time operating system (OS), which provides an assured degree of availability and low latency. As discussed below, processing in a cloud system may also be implemented if such availability and latency problems are addressed.

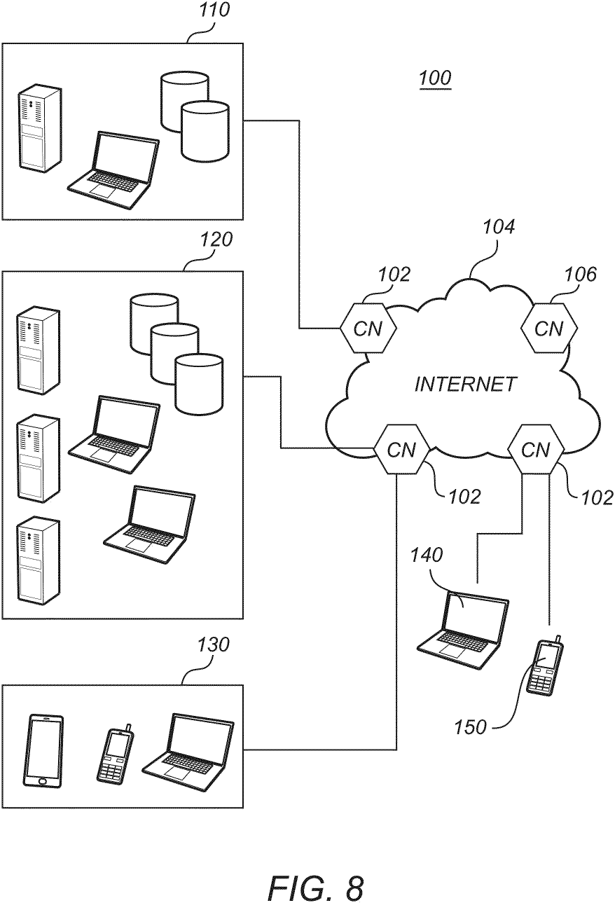

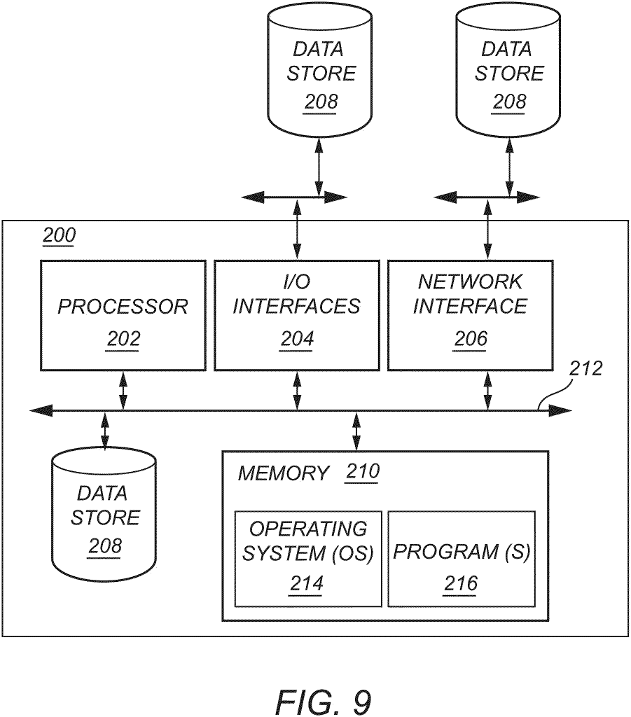

FIG. 8 is a network diagram of a cloud-based system 100 for implementing various cloud-based services of the present disclosure, where applicable. The cloud-based system 100 includes one or more cloud nodes (CNs) 102 communicatively coupled to the Internet 104 or the like. The cloud nodes 102 may be implemented as a server or other processing system 200 (as illustrated in FIG. 9) or the like and can be geographically diverse from one another, such as located at various data centers around the country or globe. Further, the cloud-based system 100 can include one or more central authority (CA) nodes 106, which similarly can be implemented as the server 200 and be connected to the CNs 102. For illustration purposes, the cloud-based system 100 can connect to a regional office 110, headquarters 120, various individual’s homes 130, laptops/desktops 140, and mobile devices 150, each of which can be communicatively coupled to one of the CNs 102. These locations 110, 120, and 130, and devices 140 and 150 are shown for illustrative purposes, and those skilled in the art will recognize there are various access scenarios to the cloud-based system 100, all of which are contemplated herein. The devices 140 and 150 can be so-called road warriors, i.e., users off-site, on-the-road, etc. The cloud-based system 100 can be a private cloud, a public cloud, a combination of a private cloud and a public cloud (hybrid cloud), or the like.

Again, the cloud-based system 100 can provide any functionality through services, such as software-as-a-service (SaaS), platform-as-a-service, infrastructure-as-a-service, security-as-a-service, Virtual Network Functions (VNFs) in a Network Functions Virtualization (NFV) Infrastructure (NFVI), etc. to the locations 110, 120, and 130 and devices 140 and 150. Previously, the Information Technology (IT) deployment model included enterprise resources and applications stored within an enterprise network (i.e., physical devices), behind a firewall, accessible by employees on site or remote via Virtual Private Networks (VPNs), etc. The cloud-based system 100 is replacing the conventional deployment model. The cloud-based system 100 can be used to implement these services in the cloud without requiring the physical devices and management thereof by enterprise IT administrators.

Cloud computing systems and methods abstract away physical servers, storage, networking, etc., and instead offer these as on-demand and elastic resources. The National Institute of Standards and Technology (NIST) provides a concise and specific definition which states cloud computing is a model for enabling convenient, on-demand network access to a shared pool of configurable computing resources (e.g., networks, servers, storage, applications, and services) that can be rapidly provisioned and released with minimal management effort or service provider interaction. Cloud computing differs from the classic client-server model by providing applications from a server that are executed and managed by a client’s web browser or the like, with no installed client version of an application required. Centralization gives cloud service providers complete control over the versions of the browser-based and other applications provided to clients, which removes the need for version upgrades or license management on individual client computing devices. The phrase “software as a service” is sometimes used to describe application programs offered through cloud computing. A common shorthand for a provided cloud computing service (or even an aggregation of all existing cloud services) is “the cloud.” The cloud-based system 100 is illustrated herein as one example embodiment of a cloud-based system, and those of ordinary skill in the art will recognize the systems and methods described herein are not necessarily limited thereby.

FIG. 9 is a block diagram of a server or other processing system 200, which may be used in the cloud-based system 100 (FIG. 8), in other systems, or stand-alone, such as in the vehicle itself. For example, the CNs 102 (FIG. 8) and the central authority nodes 106 (FIG. 8) may be formed as one or more of the servers 200. The server 200 may be a digital computer that, in terms of hardware architecture, generally includes a processor 202, input/output (I/O) interfaces 204, a network interface 206, a data store 208, and memory 210. It should be appreciated by those of ordinary skill in the art that FIG. 9 depicts the server or other processing system 200 in an oversimplified manner, and a practical embodiment may include additional components and suitably configured processing logic to support known or conventional operating features that are not described in detail herein. The components (202, 204, 206, 208, and 210) are communicatively coupled via a local interface 212. The local interface 212 may be, for example, but is not limited to, one or more buses or other wired or wireless connections, as is known in the art. The local interface 212 may have additional elements, which are omitted for simplicity, such as controllers, buffers (caches), drivers, repeaters, and receivers, among many others, to enable communications. Further, the local interface 212 may include address, control, and/or data connections to enable appropriate communications among the aforementioned components.

The processor 202 is a hardware device for executing software instructions. The processor 202 may be any custom made or commercially available processor, a central processing unit (CPU), an auxiliary processor among several processors associated with the server 200, a semiconductor-based microprocessor (in the form of a microchip or chipset), or generally any device for executing software instructions. When the server 200 is in operation, the processor 202 is configured to execute software stored within the memory 210, to communicate data to and from the memory 210, and to generally control operations of the server 200 pursuant to the software instructions. The I/O interfaces 204 may be used to receive user input from and/or for providing system output to one or more devices or components.

The network interface 206 may be used to enable the server 200 to communicate on a network, such as the Internet 104 (FIG. 8). The network interface 206 may include, for example, an Ethernet card or adapter (e.g., 10BaseT, Fast Ethernet, Gigabit Ethernet, or 10 GbE) or a Wireless Local Area Network (WLAN) card or adapter (e.g., 802.11a/b/g/n/ac). The network interface 206 may include address, control, and/or data connections to enable appropriate communications on the network. A data store 208 may be used to store data. The data store 208 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 208 may incorporate electronic, magnetic, optical, and/or other types of storage media. In one example, the data store 208 may be located internal to the server 200, such as, for example, an internal hard drive connected to the local interface 212 in the server 200. Additionally, in another embodiment, the data store 208 may be located external to the server 200 such as, for example, an external hard drive connected to the I/O interfaces 204 (e.g., a SCSI or USB connection). In a further embodiment, the data store 208 may be connected to the server 200 through a network, such as, for example, a network-attached file server.

The memory 210 may include any of volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 210 may incorporate electronic, magnetic, optical, and/or other types of storage media. Note that the memory 210 may have a distributed architecture, where various components are situated remotely from one another but can be accessed by the processor 202. The software in memory 210 may include one or more software programs, each of which includes an ordered listing of executable instructions for implementing logical functions. The software in the memory 210 includes a suitable operating system (O/S) 214 and one or more programs 216. The operating system 214 essentially controls the execution of other computer programs, such as the one or more programs 216, and provides scheduling, input-output control, file and data management, memory management, and communication control and related services. The one or more programs 216 may be configured to implement the various processes, algorithms, methods, techniques, etc. described herein.

It will be appreciated that some embodiments described herein may include one or more generic or specialized processors (“one or more processors”) such as microprocessors; central processing units (CPUs); digital signal processors (DSPs); customized processors such as network processors (NPs) or network processing units (NPUs), graphics processing units (GPUs), or the like; field programmable gate arrays (FPGAs); and the like along with unique stored program instructions (including both software and firmware) for control thereof to implement, in conjunction with certain non-processor circuits, some, most, or all of the functions of the methods and/or systems described herein. Alternatively, some or all functions may be implemented by a state machine that has no stored program instructions, or in one or more application-specific integrated circuits (ASICs), in which each function or some combinations of certain of the functions are implemented as custom logic or circuitry. Of course, a combination of the aforementioned approaches may be used. For some of the embodiments described herein, a corresponding device in hardware and optionally with software, firmware, and a combination thereof can be referred to as “circuitry configured or adapted to,” “logic configured or adapted to,” etc. perform a set of operations, steps, methods, processes, algorithms, functions, techniques, etc. on digital and/or analog signals as described herein for the various embodiments.

Moreover, some embodiments may include a non-transitory computer-readable medium having computer-readable code stored thereon for programming a computer, server, appliance, device, processor, circuit, etc. each of which may include a processor to perform functions as described and claimed herein. Examples of such computer-readable mediums include, but are not limited to, a hard disk, an optical storage device, a magnetic storage device, a Read-Only Memory (ROM), a Programmable Read-Only Memory (PROM), an Erasable Programmable Read-Only Memory (EPROM), an Electrically Erasable Programmable Read-Only Memory (EEPROM), flash memory, and the like. When stored in the non-transitory computer-readable medium, software can include instructions executable by a processor or device (e.g., any type of programmable circuitry or logic) that, in response to such execution, cause a processor or the device to perform a set of operations, steps, methods, processes, algorithms, functions, techniques, etc. as described herein for the various embodiments.

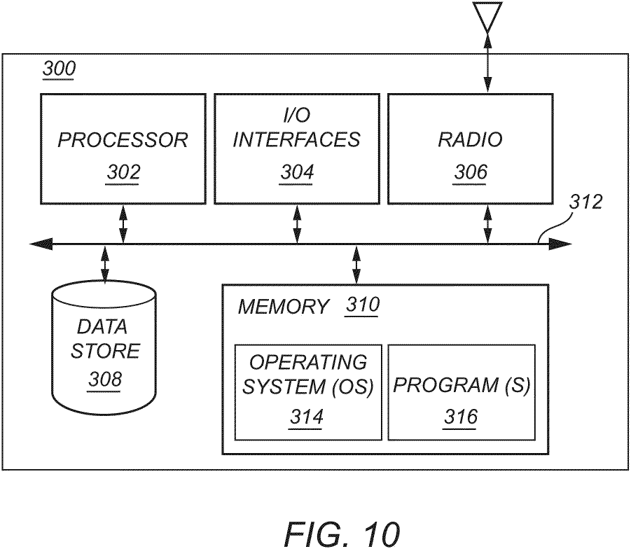

FIG. 10 is a block diagram of a user device 300, which may be used in the cloud-based system 100 (FIG. 8), as part of a network, or stand-alone. The user device 300 can be a vehicle, a smartphone, a tablet, a smartwatch, an Internet of Things (IoT) device, a laptop, a virtual reality (VR) headset, etc. The user device 300 can be a digital device that, in terms of hardware architecture, generally includes a processor 302, I/O interfaces 304, a radio 306, a data store 308, and memory 310. It should be appreciated by those of ordinary skill in the art that FIG. 10 depicts the user device 300 in an oversimplified manner, and a practical embodiment may include additional components and suitably configured processing logic to support known or conventional operating features that are not described in detail herein. The components (302, 304, 306, 308, and 310) are communicatively coupled via a local interface 312. The local interface 312 can be, for example, but is not limited to, one or more buses or other wired or wireless connections, as is known in the art. The local interface 312 can have additional elements, which are omitted for simplicity, such as controllers, buffers (caches), drivers, repeaters, and receivers, among many others, to enable communications. Further, the local interface 312 may include address, control, and/or data connections to enable appropriate communications among the aforementioned components.

The processor 302 is a hardware device for executing software instructions. The processor 302 can be any custom made or commercially available processor, a CPU, an auxiliary processor among several processors associated with the user device 300, a semiconductor-based microprocessor (in the form of a microchip or chipset), or generally any device for executing software instructions. When the user device 300 is in operation, the processor 302 is configured to execute software stored within the memory 310, to communicate data to and from the memory 310, and to generally control operations of the user device 300 pursuant to the software instructions. In an embodiment, the processor 302 may include a mobile optimized processor such as optimized for power consumption and mobile applications. The I/O interfaces 304 can be used to receive user input from and/or for providing system output. User input can be provided via, for example, a keypad, a touch screen, a scroll ball, a scroll bar, buttons, a barcode scanner, and the like. System output can be provided via a display device such as a liquid crystal display (LCD), touch screen, and the like.

The radio 306 enables wireless communication to an external access device or network. Any number of suitable wireless data communication protocols, techniques, or methodologies can be supported by the radio 306, including any protocols for wireless communication. The data store 308 may be used to store data. The data store 308 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 308 may incorporate electronic, magnetic, optical, and/or other types of storage media.

Again, the memory 310 may include any of volatile memory elements (e.g., random access memory (RAM, such as DRAM, SRAM, SDRAM, etc.)), nonvolatile memory elements (e.g., ROM, hard drive, etc.), and combinations thereof. Moreover, the memory 310 may incorporate electronic, magnetic, optical, and/or other types of storage media. Note that the memory 310 may have a distributed architecture, where various components are situated remotely from one another, but can be accessed by the processor 302. The software in memory 310 can include one or more software programs, each of which includes an ordered listing of executable instructions for implementing logical functions. In the example of FIG. 10, the software in the memory 310 includes a suitable operating system 314 and programs 316. The operating system 314 essentially controls the execution of other computer programs and provides scheduling, input-output control, file and data management, memory management, and communication control and related services. The programs 316 may include various applications, add-ons, etc. configured to provide end user functionality with the user device 300. For example, example programs 316 may include, but not limited to, a web browser, social networking applications, streaming media applications, games, mapping and location applications, electronic mail applications, financial applications, and the like. In a typical example, the end-user typically uses one or more of the programs 316 along with a network, such as the cloud-based system 100 (FIG. 8).

Although the present disclosure is illustrated and described herein with reference to illustrative embodiments and specific examples thereof, it will be readily apparent to those of ordinary skill in the art that other embodiments and examples may perform similar functions and/or achieve like results. All such equivalent embodiments and examples are within the spirit and scope of the present disclosure, are contemplated thereby, and are intended to be covered by the following non-limiting claims for all purposes.

What is claimed is:

1. A system, comprising:
a radar device coupled to a vehicle;
memory storing instructions executed by a processor to project a 3D x-y-z point cloud obtained from the radar device into a 2D plane by selecting all points within a predetermined height range and projecting the points to a 2D x-y plane by compressing the heights, sampling each azimuth direction with a fixed angle Δθ, for each sampling sector, selecting a closest point, if it exists, and locating a virtual point at a boundary otherwise, and connecting all selected points in sequence to form a radar polygon; and
a vehicle control system operable for alerting a driver to objects within the radar polygon and/or controlling the vehicle responsive to objects within the radar polygon.

2. The system of claim 1, wherein each of the points of the radar polygon comprises a velocity obtained from the radar device via a Doppler reading resulting in a deformable radar polygon.

3. The system of claim 2, wherein the deformable radar polygon represents free space around the vehicle and the shape of such deformable radar polygon is predicted at a future timestamp for use in a downstream application.

4. The system of claim 2, wherein the deformable radar polygon comprises groups of edges that are utilized by a collision detection/avoidance application.

5. The system of claim 1, wherein the radar polygon is stabilized via temporal processing/filtering.

6. The system of claim 1, wherein the radar device comprises an automotive mmWave radar device.

7. A method, comprising:
receiving a 3D x-y-z point cloud from a radar device coupled to a vehicle;
projecting the 3D x-y-z point cloud obtained from the radar device into a 2D plane by selecting all points within a predetermined height range and projecting the points to a 2D x-y plane by compressing the heights, sampling each azimuth direction with a fixed angle Δθ, for each sampling sector, selecting a closest point, if it exists, and locating a virtual point at a boundary otherwise, and connecting all selected points in sequence to form a radar polygon; and
alerting a driver to objects within the radar polygon and/or controlling the vehicle responsive to objects within the radar polygon using a vehicle control system.

8. The method of claim 7, wherein each of the points of the radar polygon comprises a velocity obtained from the radar device via a Doppler reading resulting in a deformable radar polygon.

9. The method of claim 8, wherein the deformable radar polygon represents free space around the vehicle and the shape of such deformable radar polygon is predicted at a future timestamp for use in a downstream application.

10. The method of claim 8, wherein the deformable radar polygon comprises groups of edges that are utilized by a collision detection/avoidance application.

11. The method of claim 7, wherein the radar polygon is stabilized via temporal processing/filtering.

12. The method of claim 7, wherein the radar device comprises an automotive mmWave radar device.

13. The method of claim 7, further comprising controlling a steering or braking operation of the vehicle responsive to the objects within the radar polygon using the vehicle control system.

14. A non-transitory computer-readable medium comprising instructions stored in a memory and executed by a processor to carry out steps comprising:
receiving a 3D x-y-z point cloud from a radar device coupled to a vehicle;
projecting the 3D x-y-z point cloud obtained from the radar device into a 2D plane by selecting all points within a predetermined height range and projecting the points to a 2D x-y plane by compressing the heights, sampling each azimuth direction with a fixed angle Δθ, for each sampling sector, selecting a closest point, if it exists, and locating a virtual point at a boundary otherwise, and connecting all selected points in sequence to form a radar polygon; and
alerting a driver to objects within the radar polygon and/or controlling the vehicle responsive to objects within the radar polygon using a vehicle control system.

15. The non-transitory computer-readable medium of claim 14, wherein each of the points of the radar polygon comprises a velocity obtained from the radar device via a Doppler reading resulting in a deformable radar polygon.

16. The non-transitory computer-readable medium of claim 15, wherein the deformable radar polygon represents free space around the vehicle and the shape of such deformable radar polygon is predicted at a future timestamp for use in a downstream application.

17. The non-transitory computer-readable medium of claim 15, wherein the deformable radar polygon comprises groups of edges that are utilized by a collision detection/avoidance application.

18. The non-transitory computer-readable medium of claim 14, wherein the radar polygon is stabilized via temporal processing/filtering.

19. The non-transitory computer-readable medium of claim 14, wherein the radar device comprises an automotive mmWave radar device.

20. The non-transitory computer-readable medium of claim 14, the steps further comprising controlling a steering or braking operation of the vehicle responsive to the objects within the radar polygon using the vehicle control system.
